(19) United States
(12) Patent Application Publication
(10) Pub. No.: US 2016/0136588 A1
(43) Pub. Date: May 19, 2016

(54) ZWITTERIONIC SULFONE POLYMER BLEND AND HOLLOW-FIBER MEMBRANE

(71) Applicant: General Electric Company, Schenectady, NY (US)

(72) Inventors: Hongyi Zhou, Niskayuna, NY (US); Matthew Jeremiah Misner, Delanson, NY (US); Wei Yuan, Westborough, MA (US); Julie-Anne Mason Burdick, Westborough, MA (US); Peter Joseph McGuirk, Westborough, MA (US); Jack Edward Howson, Niskayuna, NY (US); Robert Douglas Burchesky, Westborough, MA (US)

(21) Appl. No.: 14/958,937

(22) Filed: Dec. 4, 2015

Related U.S. Application Data
(63) Continuation-in-part of application No. 14/547,306, filed on Nov. 19, 2014.

(51) Int. Cl. B01D 71/80; B01D 69/08; B01D 69/02; B01D 71/68; B01D 63/02; B01D 67/00; C08L 81/06; B01D 61/28

(52) U.S. Cl. CPC B01D 71/80; C08L 81/06; B01D 69/08; B01D 61/28; B01D 71/68; B01D 63/02; B01D 67/002; B01D 69/02; C08L 2205/025; B01D 2325/18; B01D 2323/36; B01D 2323/12

(57) ABSTRACT

Provided herein are blends of polymers which are suitable for preparation of hollow fiber membranes. The polymer blends comprise a blend of a first polymer comprising a sulfone polymer having zwitterionic functionality and a second polymer comprising a sulfone polymer.

### CROSS REFERENCE TO RELATED APPLICATIONS

This application is a Continuation in part of U.S. patent application Ser. No. 14/547,306 titled “Zwitterion-Functionalized Polymer Hollow-Fiber Membranes And Associated Method” filed Nov. 19, 2014, which is incorporated herein by reference in its entirety.

### BACKGROUND

This disclosure relates generally to polymer blends used for making hollow fiber membranes. The polymer blends comprise at least one polymer comprising zwitterionic groups.

Porous hollow-fiber polymeric membranes are employed in many applications such as hemodialysis, ultrafiltration, nanofiltration, reverse osmosis, gas separation, microfiltration, and pervaporation. For many of these applications, membranes with optimal selectivity as well as chemical, thermal and mechanical stability are desirable. In many applications (for example, bio-separation or water filtration) it may also be desirable to have membranes with one or more of improved hydrophilicity, improved biocompatibility, or low fouling.

Polyarylene ethers, in particular, polyethersulfones and polysulfones are often used as membrane materials because of their mechanical, thermal, and chemical stability. However, these polymers are hydrophobic and lack the biocompatibility and hydrophilicity required for aqueous applications Improvements in membrane hydrophilicity have been achieved by polymer blending, for example, fabricating the porous membrane in the presence of small amounts of hydrophilic polymers such as polyvinylpyrollidone (PVP). However, since PVP is water-soluble it is slowly leached from the porous polymer matrix creating product variability. Alternatively, hydrophilicity has been achieved via functionalization of the polymer backbone and introduction of carboxyl, nitrile or polyethylene glycol functionality. However, these chemical modifications may be complicated, expensive and inefficient. Further, addition of the functional groups may make it difficult to fabricate hollow-fiber membranes from the functionalized polymers. One approach to solving the problems due to functional groups has been to functionalize the membranes post-fabrication; but such an approach increases the cost of manufacture of the membranes.

There is a need in the field for materials which are easy to process and/or fabricate into membranes, including hollow fiber membranes, but which also reduce protein binding and/or fouling and provide good mechanical properties suited for aqueous applications.

### BRIEF DESCRIPTION

Provided herein are polymer blends which alleviate certain limitations of previously known methods for the manufacture of hollow fiber membranes. The present blends increase processability of functionalized polymers and also reduce the need for post-casting functionalization of membranes.

Provided herein are hollow-fiber membranes, comprising a blend of a first polymer comprising a sulfone polymer having zwitterionic functionality and a second polymer comprising a sulfone polymer:

In one aspect, provided herein are hollow-fiber membranes, comprising a blend of a first polymer comprising a sulfone polymer having zwitterionic functionality and a second polymer comprising a sulfone polymer, wherein the first polymer comprising a sulfone polymer having zwitterionic functionality comprises structural units of formula IA or formula IB attached to structural units of formula II and wherein the second polymer comprising a sulfone polymer comprises structural units having the structure of formula II, III, IV, or V, wherein the structures of formula IA, IB, II, III, IV, and V are as described in the detailed description section below.

### DRAWINGS

These and other features, aspects, and advantages of the present invention will become better understood when the following detailed description is read with reference to the accompanying drawings in which like characters represent like parts throughout the drawings, wherein:

FIG. 1 shows a comparison between a cross section of a hollow fiber membrane comprising high molecular weight polymers and a hollow fiber membrane comprising the instantly claimed polymer blends.

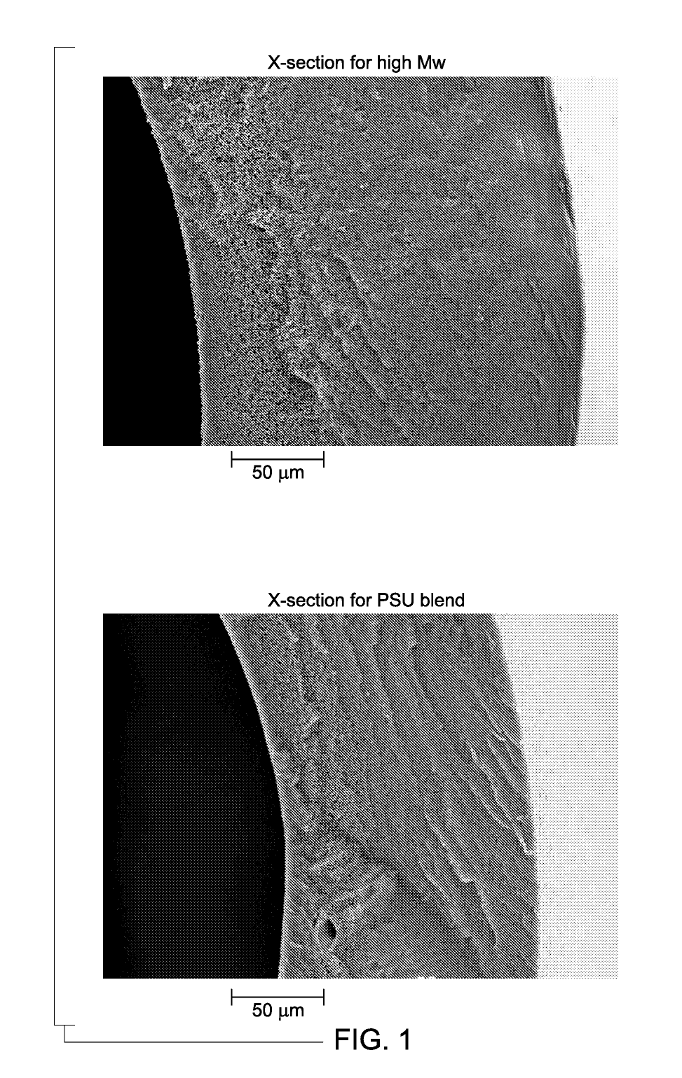

FIG. 2 shows a comparison between protein binding properties (fouling) of hollow fiber membranes: (1) high molecular weight polysulfone (PSU) (MW 54 kg/mol) ultrafiltration hollow fiber membrane, (2) high molecular weight polysulfone (PSU) (MW 54 kg/mol) microfiltration hollow fiber membrane, (3) PSU comprising zwitterionic groups (ZwPSU) microfiltration hollow fiber membrane, (4) microfiltration hollow fiber membrane comprising the present polymer blends (MW-49.3 kg/mol), and (5) PSU comprising zwitterionic groups (ZwPSU) microfiltration hollow fiber membrane. No impact or minimal impact was observed on the morphology and IgG binding (ELISA) in going from high molecular weight polymers to the blends of polymers.

### DETAILED DESCRIPTION

Hollow fiber membranes are typically employed in applications where a hydrophilic and/or biocompatible barrier is required. Zwitterionic sulfone polymers are hydrophilic and cause low protein binding and biofouling. However, zwitterionic sulfone polymers tend to be difficult to process into membranes, and the resulting membranes often have poor mechanical properties. Previous attempts at improving hydrophilicity of sulfone-polymer-containing membranes have focused on post-fabrication functionalization of polymers and/or membranes.

By contrast, provided herein are novel blends of polymers comprising sulfone polymers and zwitterionic sulfone polymers which alleviate the need for post-fabrication functionalization of membranes. Further, the polymeric blends described herein can improve polymer network structure and result in better mechanical performance. The polymer blends described herein also confer improved processability allowing for easier manufacture of membranes, including hollow fiber membranes. In addition, the polymer blends described herein provide the desired hydrophilicity and/or biocompatibility to the membranes. Thus, by blending a low amount of sulfone polymers with zwitterionic sulfone polymers, the processability of zwitterionic sulfone polymers into membranes is improved. Further, the mechanical properties of membranes comprising said polymeric blends are significantly improved while maintaining membrane morphology and low binding characteristics of the membranes. Advantageously, the present membranes alleviate problems associated with leaching of water soluble polymers such as PVP from the matrix, thereby reducing product variability.

The polymer blends described herein provide easy adjustment and significant improvement of membrane processibility (e.g. low dope viscosity) and mechanical property (e.g. high tensile elongation), and also provide some cost reduction by replacing expensive zwitterionic sulfone polymers with less expensive sulfone polymers in the blends.

### CERTAIN TERMS

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein a “sulfone polymer” is any polymer comprising one or more subunits of structure aryl-SO₂-aryl. Typically sulfone polymers are prepared via a reaction between a diphenol and a bis(4-chlorophenyl)sulfone by elimination of sodium chloride: Sulfone polymers include and are not limited to polysulfones, polyarylsulfones (alternatively referred to as polyphenylsulfones, or polyphenylenesulfones), polyethersulfones, and the like.

As used herein a “sulfone polymer having zwitterionic functionality” or a “zwitterionic sulfone polymer” is any polymer comprising one or more subunits of structure aryl-SO₂-aryl and having one or more subunits comprising zwitterionic functionality.

The term “hollow-fiber membrane” as used herein refers to fiber-based membrane structures including separating layers present at the surface. The hollow-fiber membrane may function using “inside-outside” or “outside-inside” mechanism. The terms “hollow-fiber membrane” and “membrane” are used herein interchangeably, unless the context clearly indicates otherwise.

The term “alkyl” refers to a straight- or branched-chain alkyl group having from 1 to 12 carbon atoms in the chain. Examples of alkyl groups include methyl (Me) ethyl (Et), n-propyl, isopropyl, butyl, isobutyl, sec-butyl, tert-butyl (tBu), pentyl, isopentyl, tert-pentyl, hexyl, isohexyl, and the like.

“Cycloalkyl” refers to monocyclic or polycyclic non-aromatic hydrocarbon groups having from 3 to 12 carbon atoms. Non-limiting of cycloalkyl groups include, cyclopropyl, cyclobutyl, cyclopentyl, cyclohexyl, 1-methylcyclopropyl, 2-methylcyclopentyl, octahydro-1H-indene, decahydronaphthalene, and the like.

The term “aryl” represents a mono- or bi-cyclic aromatic, hydrocarbon ring structure. Aryl rings can have 6 or 10 carbon atoms in the ring.

Described herein are hollow-fiber membranes, comprising a blend of a first polymer comprising a sulfone polymer having zwitterionic functionality and a second polymer comprising a sulfone polymer.

In one aspect are hollow-fiber membranes, comprising a blend of a first polymer comprising a sulfone polymer having zwitterionic functionality and a second polymer comprising a sulfone polymer wherein the first polymer comprising a sulfone polymer having zwitterionic functionality comprises structural units of formula IA or formula IB attached to structural units of formula II:

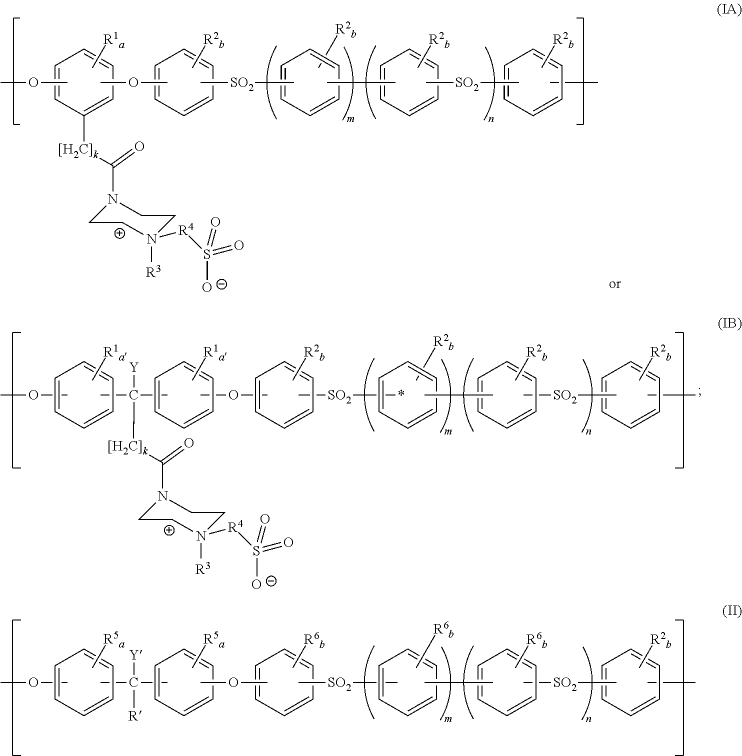

wherein

R¹ and R² are independently at each occurrence a hydrogen atom, a halogen atom, a nitro group, a C₁-C₁₂ alkyl, a C₃-C₁₂ cycloalkyl, or an aryl ring;

k is from 0 to 10;

Y′ and R′ are each, independently, hydrogen, C₁-C₂₀ alkyl, or an aryl ring;

R⁴ is a bond, a C₁-C₁₂ alkyl, a C₃-C₁₂ cycloalkyl, or an aryl ring;

R⁵ and R⁶ are independently at each occurrence a hydrogen atom, a halogen atom, a nitro group, a C₁-C₁₂ alkyl, a C₃-C₁₂ cycloalkyl, or an aryl ring; and

Y′ and R′ are each, independently, hydrogen, C₁-C₂₀ alkyl, or an aryl ring;

a, a′ and b are independently at each occurrence 0, 1, 2, 3, or 4;

and

m and n are each, independently, 0 or 1.

In another aspect are hollow-fiber membranes, comprising a blend of a first polymer comprising a sulfone polymer having zwitterionic functionality and a second polymer comprising a sulfone polymer, wherein the second polymer comprising a sulfone polymer comprises structural units having the structure of formula II, III IV, or V

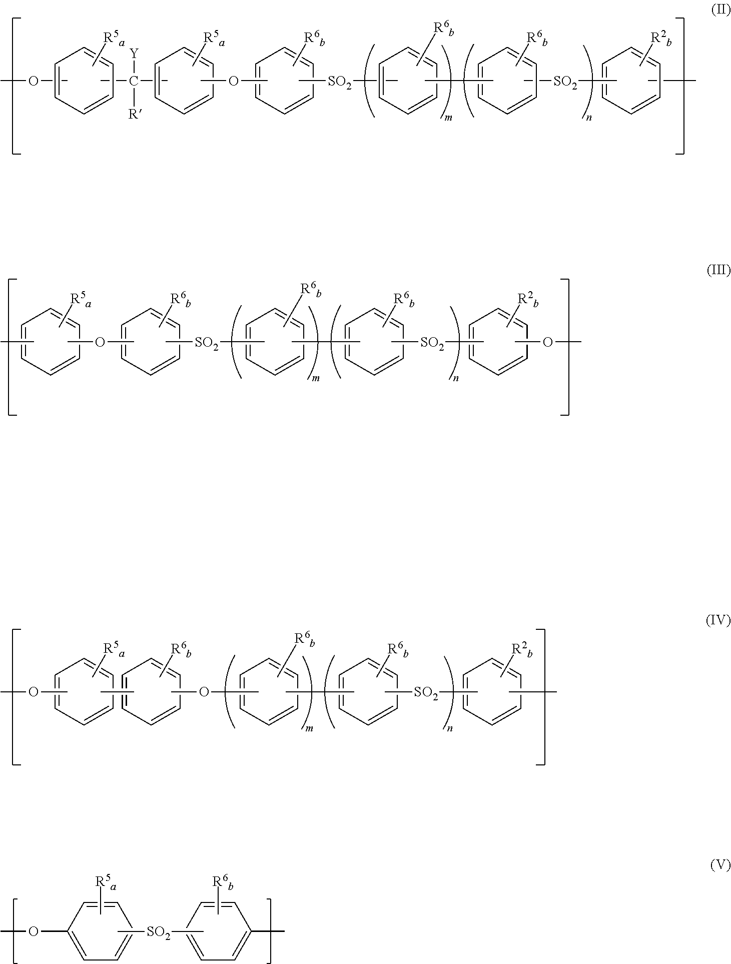

wherein

R⁵ and R⁶ are independently at each occurrence a hydrogen atom, a halogen atom, a nitro group, a C₁-C₁₂ alkyl, a C₃-C₁₂ cycloalkyl, or an aryl ring; and

Y′ and R′ are each, independently, hydrogen, C₁-C₂₀ alkyl, or an aryl ring;

a and b are independently at each occurrence 0, 1, 2, 3, or 4; and

m and n are each, independently, 0 or 1.

In some embodiments of the hollow fiber membranes described above, the first polymer comprising a sulfone polymer having zwitterionic functionality comprises structural units of formula IA or formula IB attached to structural units of formula II:

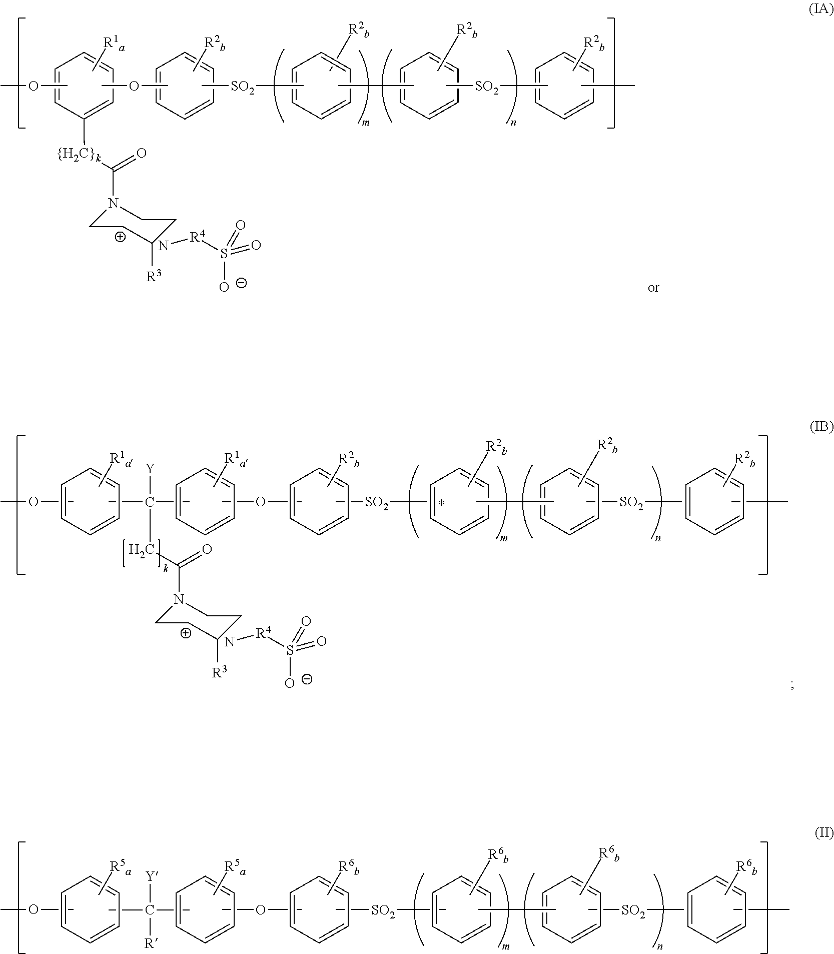

wherein

R¹ and R² are independently at each occurrence a hydrogen atom, a halogen atom, a nitro group, a C₁-C₁₂ alkyl, a C₃-C₁₂ cycloalkyl, or an aryl ring;

k is from 0 to 10;

Y′ and R′ are each, independently, hydrogen, C₁-C₂₀ alkyl, or an aryl ring;

R⁴ is a bond, a C₁-C₁₂ alkyl, a C₃-C₁₂ cycloalkyl, or an aryl ring;

R⁵ and R⁶ are independently at each occurrence a hydrogen atom, a halogen atom, a nitro group, a C₁-C₁₂ alkyl, a C₃-C₁₂ cycloalkyl, or an aryl ring; and

Y′ and R′ are each, independently, hydrogen, C₁-C₂₀ alkyl, or an aryl ring;

a, a′ and b are independently at each occurrence 0, 1, 2, 3, or 4;

m and n are each, independently, 0 or 1; and

wherein the second polymer comprising a sulfone polymer comprises structural units having the structure of formula II, IV, or V

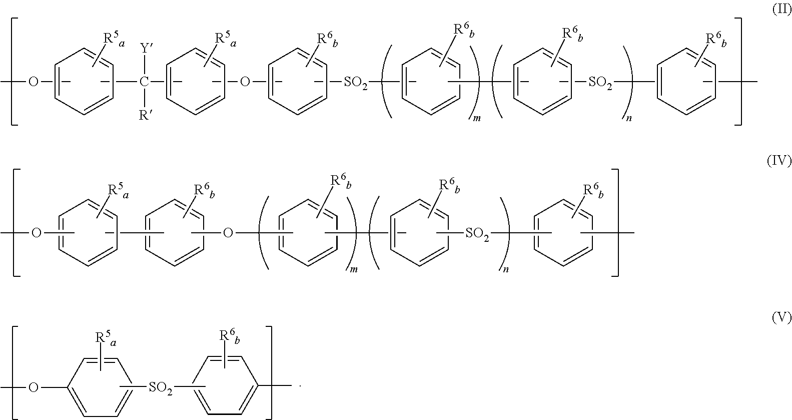

In some embodiments of the hollow fiber membranes described above, the first polymer comprising a sulfone polymer having zwitterionic functionality comprises structural units of formula VI:

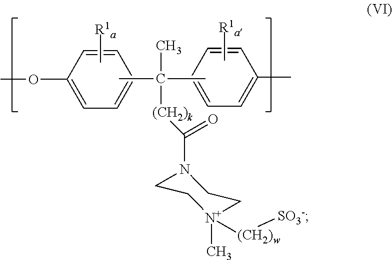

wherein w is 0, 1, 2, or 3.

In some embodiments of the hollow fiber membranes described above, the first polymer comprising a sulfone polymer having zwitterionic functionality comprises structural units of formula VII:

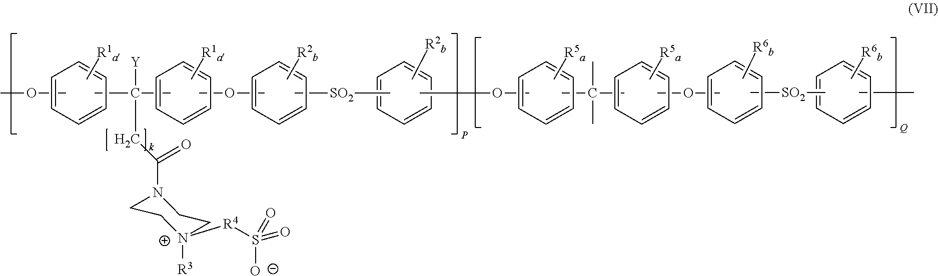

wherein P+Q=1, P=0.30-0.50, Q=0.50-0.70.

In some embodiments of the hollow fiber membranes described above, the mole fraction of the zwitterion-functionalized structural units of formula IB in the first polymer is less than about 50 mole percent of the total moles of the units of formula IB and formula II in the first polymer. In some embodiments of the hollow fiber membranes described above, the mole fraction of the zwitterion-functionalized structural units of formula IB in the first polymer is in a range from about 30 mole percent to about 50 mole percent of the total moles of the units of formula IB and formula II in the first polymer.

In some embodiments of the hollow fiber membranes described above, the molecular weight of the first polymer comprising a sulfone polymer having zwitterionic functionality is in a range from about 10000 g/mol to about 80000 g/mol.

In some embodiments of the hollow fiber membranes described above, the second polymer comprising a sulfone polymer comprises a polysulfone comprising structural units of formula II.

In some embodiments of the hollow fiber membranes described above, the second polymer comprising a sulfone polymer comprises a polyphenyl sulfone comprising structural units of formula IV.

In some embodiments of the hollow fiber membranes described above, the second polymer comprising a sulfone polymer comprises a polyethersulfone comprising structural units of formula V.

In some embodiments of the hollow fiber membranes described above, the second polymer comprising a sulfone polymer is in an amount from about 0.5 weight % to about 5 weight % of the total weight of polymer in the membrane.

In some embodiments of the hollow fiber membranes described above, the molecular weight of the second polymer comprising a sulfone polymer is in a range from about 50000 g/mol to about 80000 g/mol.

In some embodiments of the hollow fiber membranes described above, the first polymer comprising a sulfone polymer having zwitterionic functionality comprises structural units of formula IB attached to structural units of formula II, and the second polymer comprising a sulfone polymer comprises structural units of formula II

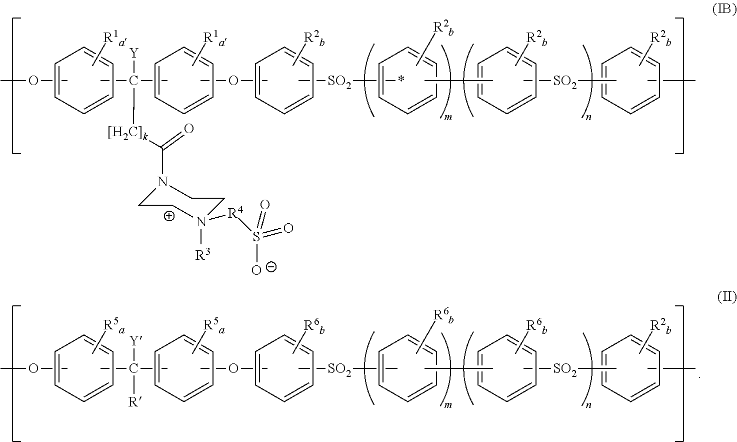

In some embodiments of the hollow fiber membranes described above, the first polymer comprising a sulfone polymer having zwitterionic functionality comprises structural units of formula IB attached to structural units of formula II, and the second polymer comprising a sulfone polymer comprises structural units of formula IV

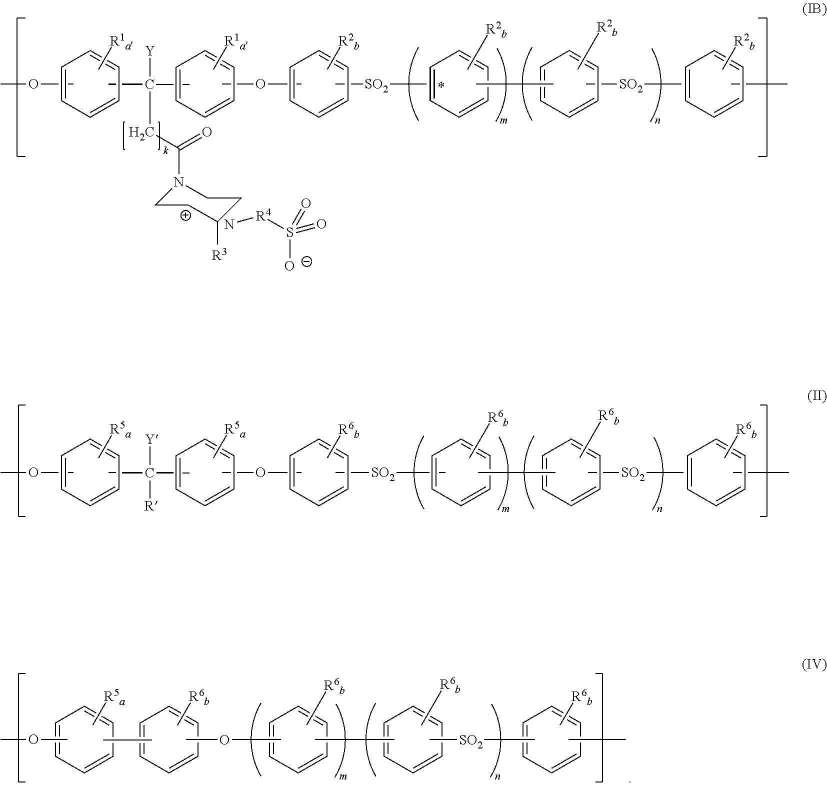

In some embodiments of the hollow fiber membranes described above, the first polymer comprising a sulfone polymer having zwitterionic functionality comprises structural units of formula IB attached to structural units of formula II, and the second polymer comprising a sulfone polymer comprises structural units of formula V

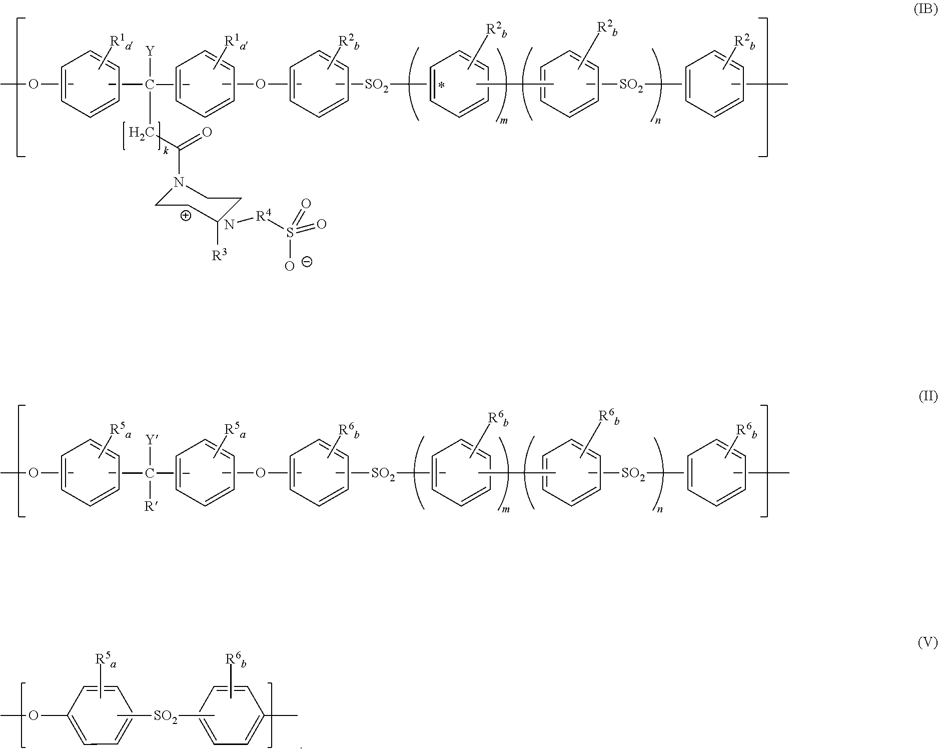

Provided herein are hollow-fiber membrane modules comprising a plurality of hollow-fiber membranes wherein the first polymer comprising a sulfone polymer having zwitterionic functionality comprises structural units of formula IB attached to structural units of formula II, and the second polymer comprising a sulfone polymer comprises structural units of formula II. Also provided herein is a hemodialysis or hemofiltration apparatus comprising a hollow-fiber membrane module wherein the first polymer comprising a sulfone polymer having zwitterionic functionality comprises structural units of formula IB attached to structural units of formula II, and the second polymer comprising a sulfone polymer comprises structural units of formula II.

Provided herein are hollow-fiber membrane modules comprising a plurality of hollow-fiber membranes wherein the first polymer comprising a sulfone polymer having zwitterionic functionality comprises structural units of formula IB attached to structural units of formula II, and the second polymer comprising a sulfone polymer comprises structural units of formula IV. Also provided herein is a hemodialysis or hemofiltration apparatus comprising a hollow-fiber membrane module wherein the first polymer comprising a sulfone polymer having zwitterionic functionality comprises structural units of formula IB attached to structural units of formula II, and the second polymer comprising a sulfone polymer comprises structural units of formula IV.

Provided herein are hollow-fiber membrane modules comprising a plurality of hollow-fiber membranes wherein the first polymer comprising a sulfone polymer having zwitterionic functionality comprises structural units of formula IB attached to structural units of formula II, and the second polymer comprising a sulfone polymer comprises structural units of formula V. Also provided herein is a hemodialysis or hemofiltration apparatus comprising a hollow-fiber membrane module wherein the first polymer comprising a sulfone polymer having zwitterionic functionality comprises structural units of formula IB attached to structural units of formula II, and the second polymer comprising a sulfone polymer comprises structural units of formula V.

In yet another aspect, provided herein is a composition comprising a blend of a first polymer comprising a sulfone polymer having zwitterionic functionality and a second polymer comprising a sulfone polymer.

In some embodiments provided herein is a composition comprising a blend of a first polymer comprising a sulfone polymer having zwitterionic functionality and a second polymer comprising a sulfone polymer wherein the first polymer comprising a sulfone polymer having zwitterionic functionality comprises structural units of formula IB attached to structural units of formula II, and the second polymer comprising a sulfone polymer comprises structural units of formula II

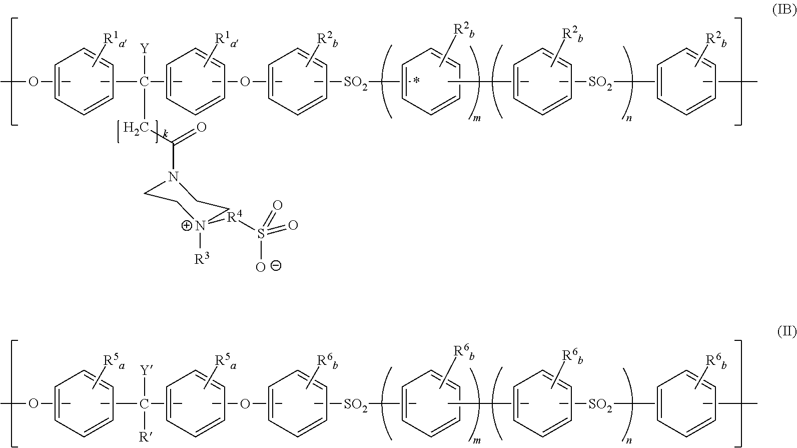

wherein

R¹ and R² are independently at each occurrence a hydrogen atom, a halogen atom, a nitro group, a C₁-C₁₂ alkyl, a C₃-C₁₂ cycloalkyl, or an aryl ring;

k is from 0 to 10;

R³ and Y are independently a hydrogen atom, a C₁-C₁₂ alkyl, a C₃-C₁₂ cycloalkyl, or an aryl ring;

R⁴ is a bond, a C₁-C₁₂ alkyl, a C₃-C₁₂ cycloalkyl, or an aryl ring;

R⁵ and R⁶ are independently at each occurrence a hydrogen atom, a halogen atom, a nitro group, a C₁-C₁₂ alkyl, a C₃-C₁₂ cycloalkyl, or an aryl ring;

a, a′ and b are independently at each occurrence 0, 1, 2, 3, or 4; and

m and n are each, independently, 0 or 1.

In some embodiments provided herein is a composition comprising a blend of a first polymer comprising a sulfone polymer having zwitterionic functionality and a second polymer comprising a sulfone polymer wherein the first polymer comprising a sulfone polymer having zwitterionic functionality comprises structural units of formula IB attached to structural units of formula II, and the second polymer comprising a sulfone polymer comprises structural units of formula IV

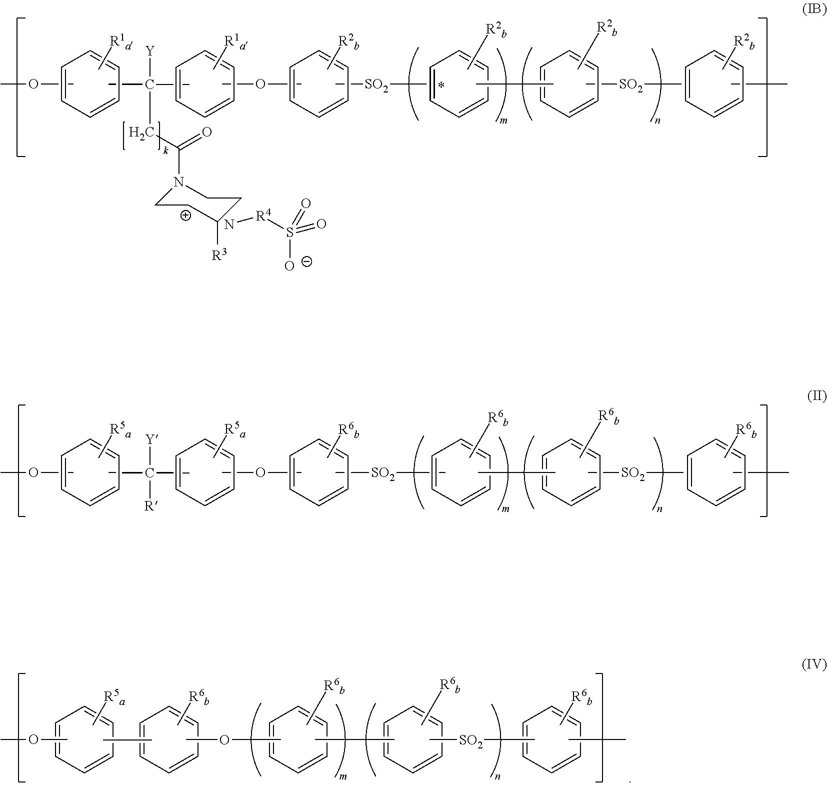

wherein

R¹ and R² are independently at each occurrence a hydrogen atom, a halogen atom, a nitro group, a C₁-C₁₂ alkyl, a C₃-C₁₂ cycloalkyl, or an aryl ring;

k is from 0 to 10;

R³ and Y are independently a hydrogen atom, a C₁-C₁₂ alkyl, a C₃-C₁₂ cycloalkyl, or an aryl ring;

R⁴ is a bond, a C₁-C₁₂ alkyl, a C₃-C₁₂ cycloalkyl, or an aryl ring;

R⁵ and R⁶ are independently at each occurrence a hydrogen atom, a halogen atom, a nitro group, a C₁-C₁₂ alkyl, a C₃-C₁₂ cycloalkyl, or an aryl ring;

a, a′ and b are independently at each occurrence 0, 1, 2, 3, or 4; and

m and n are each, independently, 0 or 1.

In some embodiments provided herein is a composition comprising a blend of a first polymer comprising a sulfone polymer having zwitterionic functionality and a second polymer comprising a sulfone polymer wherein the first polymer comprising a sulfone polymer having zwitterionic functionality comprises structural units of formula IB attached to structural units of formula II, and the second polymer comprising a sulfone polymer comprises structural units of formula V

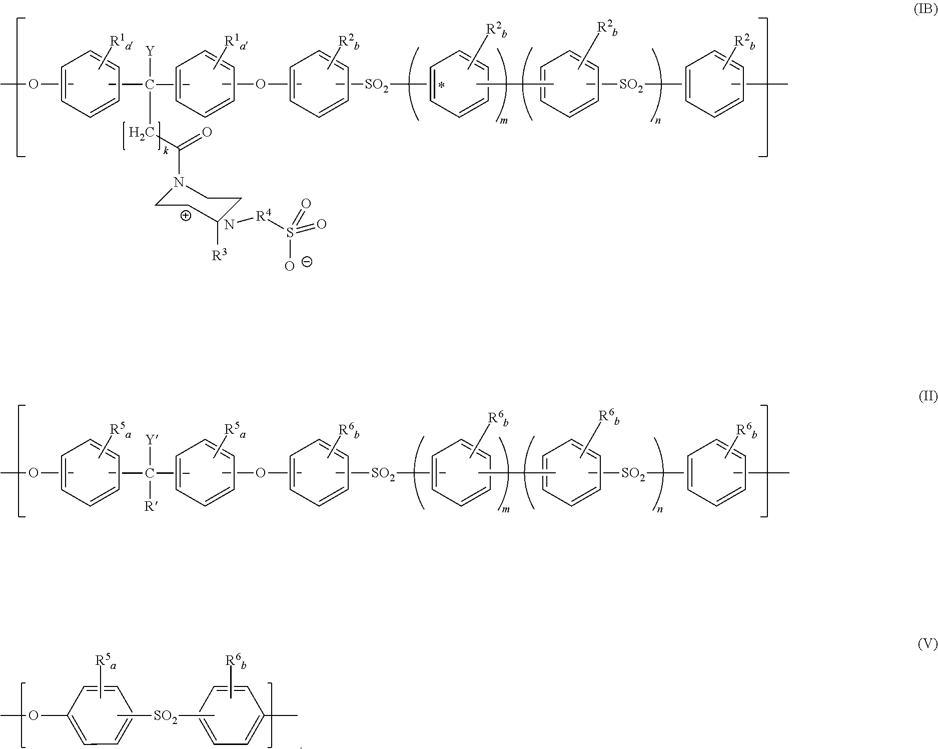

wherein

R¹ and R² are independently at each occurrence a hydrogen atom, a halogen atom, a nitro group, a C₁-C₁₂ alkyl, a C₃-C₁₂ cycloalkyl, or an aryl ring;

k is from 0 to 10;

R³ and Y are independently a hydrogen atom, a C₁-C₁₂ alkyl, a C₃-C₁₂ cycloalkyl, or an aryl ring;

R⁴ is a bond, a C₁-C₁₂ alkyl, a C₃-C₁₂ cycloalkyl, or an aryl ring;

R⁵ and R⁶ are independently at each occurrence a hydrogen atom, a halogen atom, a nitro group, a C₁-C₁₂ alkyl, a C₃-C₁₂ cycloalkyl, or an aryl ring;

a, a′ and b are independently at each occurrence 0, 1, 2, 3, or 4; and

m and n are each, independently, 0 or 1.

Also provided herein is a process for forming hollow-fiber membranes described herein comprising:

(A) providing a casting solution comprising a blend of the first polymer and the second polymer, wherein the total polymer content in the casting solution is less than about 20% by weight of the casting solution; and

(B) extruding the casting solution through an annular channel to form the hollow-fiber membrane.

In alternate embodiments, the casting solution may have a total polymer content in the casting solution which is less than about 50% by weight of the casting solution. In additional embodiments, the casting solution may have a total polymer content in the casting solution which is between about 10% and about 30% by weight of the casting solution. It will be understood that the actual content of polymers in the membrane may not always be identical to the amount of polymers in the casting solution (dope). By way of illustration only, a 2.5 weight % sulfone polymer (second polymer) content in the membrane may arise from 0.4 weight % sulfone polymer in the casting solution along with 15.6 weight % of the sulfone polymer comprising zwitterionic functionality in the casting solution.

In certain embodiments, the hollow-fiber membrane which is formed from step (B) above comprises the second polymer in an amount from about 0.5 weight % to about 5 weight % of the total weight of polymer in the membrane. In other embodiments, the hollow-fiber membrane which is formed from step (B) above comprises the second polymer in an amount from about 0.5 weight % to about 3 weight % of the total weight of polymer in the membrane

The sulfone polymers and/or the sulfone polymers having zwitterionic functionality described herein are synthesized using any suitable techniques known in the art. In certain embodiments, the sulfone polymer are synthesized by reacting at least one aromatic dihydroxy compound with at least one aromatic dihalide compound. At least one of the aromatic dihydroxy compound and the aromatic dihalide compound may be functionalized with a suitable functional group (for example, piperazine amide group) capable of being converted to the zwitterion functional group. In some embodiments, the aromatic dihydroxy compound may be functionalized with a suitable functional group. Further, at least one of the aromatic dihydroxy compound and the aromatic dihalide compound may include a sulfone moiety. In some embodiments, the aromatic dihalide compound may include the sulfone moiety.

Exemplary aromatic dihalide compounds that may be used include 4,4′-bis(chlorophenyl)sulfone, 2,4′-bis(chlorophenyl)sulfone, 2,4-bis(chlorophenyl)sulfone, 4,4-bis(fluorophenyl)sulfone, 2,4′-bis(fluorophenyl)sulfone, 2,4-bis(fluorophenyl)sulfone, 4,4′-bis(chlorophenyl)sulfoxide, 2,4′-bis(chlorophenyl)sulfoxide, 2,4-bis(chlorophenyl)sulfoxide, 4,4-bis(fluorophenyl)sulfoxide, 2,4′-bis(fluorophenyl)sulfoxide, 2,4-bis(fluorophenyl)sulfoxide, 4,4′-bis(fluorophenyl)ketone, 2,4′-bis(fluorophenyl)ketone, 2,4-bis(fluorophenyl)ketone, 1,3-bis(4-fluorobenzoyl)benzene, 1,4-bis(4-fluorobenzoyl)benzene, 4,4′-bis(4-chlorophenyl)phenylphosphine oxide, 4,4′-bis(4-fluorophenyl)phenylphosphine oxide, 4,4′-bis(4-fluorophenylsulfonyl)-1,1′-biphenyl, 4,4′-bis(4-chlorophenylsulfonyl)-1,1′-biphenyl, 4,4′-bis(4-fluorophenylsulfoxide)-1,1′-biphenyl, 4,4′-bis(4-chlorophenylsulfoxide)-1,1′-biphenyl, and combinations thereof.

Non-limiting examples of suitable aromatic dihydroxy compounds that may be used include 4,4′-dihydroxyphenyl sulfone, 2,4′-dihydroxyphenyl sulfone, 4,4′-dihydroxyphenyl sulfoxide, 2,4′-dihydroxyphenyl sulfoxide, bis(3,5-dimethyl-4-hydroxyphenyl)sulfoxide, bis(3,5-dimethyl-4-hydroxyphenyl)sulfone, 4,4-(phenylphosphinyl)diphenol, 4,4′-oxydiphenol,4,4′-thiodiphenol, 4,4′-dihydroxybenzophenone, 4,4′dihydroxyphenylmethane, hydroquinone, resorcinol, 5-cyano-1,3-dihydroxybenzene, 4-cyano-1,3,-dihydroxybenzene, 2-cyano-1,4-dihydroxybenzene, 2-methoxyhydroquinone, 2,2′-biphenol, 4,4′-biphenol, 2,2′-dimethylbiphenol 2,2′,6,6′-tetramethylbiphenol, 2,2′,3,3′,6,6′-hexamethylbiphenol, 3,3′,5,5′-tetrabromo-2,2′6,6′-tetramethylbiphenol, 4,4′-isopropylidenediphenol (bisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′-isopropylidenebis(2-allyl-6-methylphenol), 4,4′(1,3-phenylenediisopropylidene)bisphenol (bisphenol M), 4,4′-isopropylidenebis(3-phenylphenol), 4,4′-isopropylidene-bis(2-phenylphenol), 4,4′-(1,4-phenylenediisoproylidene)bisphenol (bisphenol P), 4,4′-ethylidenediphenol (bisphenol E), 4,4′-oxydiphenol, 4,4′-thiodiphenol, 4,4′-thiobis(2,6-dimethylphenol), 4,4′-sufonyldiphenol, 4,4′-sufonylbis(2,6-dimethylphenol) 4,4′-sulfinyldiphenol, 4,4′-hexafluoroisoproylidene)bisphenol (Bisphenol AF), 4,4′-hexafluoroisoproylidene)bis(2,6-dimethylphenol), 4,4′-(1-phenylethylidene)bisphenol (Bisphenol AP), 4,4′-(1-phenylethylidene)bis(2,6-dimethylphenol), bis(4-hydroxyphenyl)-2,2-dichloroethylene (Bisphenol C), bis(4-hydroxyphenyl)methane (Bisphenol-F), bis(2,6-dimethyl-4-hydroxyphenyl)methane, 2,2-bis(4-hydroxyphenyl)butane, 3,3-bis(4-hydroxyphenyl)pentane, 4,4′-(cyclopentylidene)diphenol, 4,4′-(cyclohexylidene)diphenol (Bisphenol Z), 4,4′-(cyclohexylidene)bis(2-methylphenol), 4,4′-(cyclododecylidene)diphenol, 4,4′-(bicyclo[2.2.1]heptylidene)diphenol, 4,4′-(9H-fluorene-9,9-diyl)diphenol, 3,3′-bis(4-hydroxyphenyl)isobenzofuran-1 (3H)-one, 1-(4-hydroxyphenyl)-3,3′-dimethyl-2,3-dihydro-1H-inden-5-ol, 1-(4-hydroxy-3,5-dimethylphenyl)-1,3,3′,4,6-pentamethyl-2,3-dihydro-1H-in-den-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), thiodiphenol (Bisphenol S), bis(4-hydroxyphenyl)diphenyl methane, bis(4-hydroxyphenoxy)-4,4′-biphenyl, 4,4′-bis(4-hydroxyphenyl)diphenyl ether, 9,9-bis(3-methyl-4-hydroxyphenyl) fluorene, N-phenyl-3,3-bis-(4-hydroxyphenyl)phthalimide, and combinations thereof.

The reaction may be effected in a polar aprotic solvent in the presence of an alkali metal compound, and optionally, in the presence of catalysts. A basic salt of an alkali metal compound may be used to effect the reaction between the dihalo and dihydroxy aromatic compounds. Exemplary compounds include alkali metal hydroxides, such as, but not limited to, lithium hydroxide, sodium hydroxide, potassium hydroxide, rubidium hydroxide, and cesium hydroxide; alkali metal carbonates, such as, but not limited to, lithium carbonate, sodium carbonate, potassium carbonate, rubidium carbonate, and cesium carbonate; and alkali metal hydrogen carbonates, such as but not limited to lithium hydrogen carbonate, sodium hydrogen carbonate, potassium hydrogen carbonate, rubidium hydrogen carbonate, and cesium hydrogen carbonate. Combinations of these compounds may also be used to effect the reaction.

Some examples of aprotic polar solvents include and are not limited to N,N-dimethylformamide, N,N-diethylformamide, N,N-dimethylacetamide, N,N-diethylacetamide, N,N-dipropylacetamide, N,N-dimethylbenzamide, N-methyl-2-pyrrolidone (NMP), N-ethyl-2-pyrrolidone, N-isopropyl-2-pyrrolidone, N-isobutyl-2-pyrrolidone, N-n-propyl-2-pyrrolidone, N-n-butyl-2-pyrrolidone, N-cyclohexyl-2-pyrrolidone, N-methyl-3-methyl-2-pyrrolidone, N-ethyl-3-methyl-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, N-methyl-3-ethylpiperidone, dimethylsulfoxide (DMSO), diethylsulfoxide, sulfolane, 1-methyl-1-oxosulfolane, 1-ethyl-1-oxosulfolane, 1-phenyl-1-oxosulfolane, N,N′-dimethylimidazolidinone (DMI), diphenylsulfone, and combinations thereof. The amount of solvent to be used is typically an amount that is sufficient to dissolve the dihalo and dihydroxy aromatic compounds.

The reaction may be conducted at a temperature in a range from about 100° C. to about 300° C. in some embodiments, from about 120° C. to about 200° C. in some embodiments, and from about 150° C. to about 200° C. in particular embodiments. The reaction mixture may be further dried by addition to the initial reaction mixture of, along with the polar aprotic solvent, a solvent that forms an azeotrope with water. Examples of such solvents include toluene, benzene, xylene, ethylbenzene and chlorobenzene. After removal of residual water by azeotropic drying, the reaction may be carried out at the elevated temperatures described above. The reaction is typically conducted for a time period ranging from about 1 hour to about 72 hours in some embodiments, and from about 1 hour to about 10 hours in particular embodiments.

After completion of the reaction, the polymer may be separated from the inorganic salts, precipitated into a non-solvent and collected by filtration and drying. Examples of non-solvents include water, methanol, ethanol, propanol, butanol, acetone, methyl ethyl ketone, methyl isobutyl ketone, and combinations thereof.

The glass transition temperature, T_{g}, of the polymers described herein may be in a range from about 120° C. to about 280° C. in one embodiment, and may be in a range from about 140° C. to about 200° C. in another embodiment. The polymers may be further characterized by the weight average molecular weight (M_{w}) obtained from gel permeation chromatography based on polystyrene standards. In one embodiment, the M_{w} of the polymer may be in the range from about 10000 grams per mole (g/mol) to about 100000 g/mol. In another embodiment, the M_{w} may be in a range from about 10000 g/mol to about 75000 g/mol. In another embodiment, the M_{w} may be in a range from about 40000 g/mol to about 55000 g/mol. In a further embodiment, the M_{w} may be in a range from about 50000 g/mol to about 80000 g/mol.

Mechanical testing is conducted by using an Instron (Model 4202). In a typical test, a segment of hollow fiber membrane with a length of about 2-in is loaded in a pair of pneumatic clamps leaving a gauge length of exactly 1-in. The test sample is stretched at a rate of 0.5-in/min, and the test is stopped when the sample is broken. Data recorded from the test include sample modulus, maximum load and maximum elongation, load and elongation at break.

The polymers and the membranes including the blended polymers described herein may be further characterized by their respective hydrophilicities. In some embodiments, the sulfone polymer having zwitterionic functionality has a contact angle with water less than about 80 degrees measured on a surface of the polymer cast as a film on a glass substrate. In some embodiments, the sulfone polymer having zwitterionic functionality has a contact angle with water less than about 50 degrees measured on a surface of the polymer cast as a film on a glass substrate. In particular embodiments, the sulfone polymer having zwitterionic functionality has a contact angle with water less than about 30 degrees measured on a surface of the polymer cast as a film on a glass substrate.

The membranes in accordance with embodiments described herein are made by processes known in the art. Suitable techniques include, but are not limited to: dry-phase separation membrane formation process; wet-phase separation membrane formation process; dry-wet phase separation membrane formation process; thermally-induced phase-separation membrane formation process. Further, post membrane-formation, the membrane may be subjected to a membrane conditioning process or a treatment process prior to its use in a separation application. Representative processes may include thermal annealing to relieve stresses or pre-equilibration in a solution similar to the feed stream the membrane will contact.

In one embodiment, the membranes may be prepared by phase inversion. The phase inversion process includes 1) vapor-induced phase separation (VIPS), also called “dry casting” or “air casting”; 2) liquid-induced phase separation (LIPS), mostly referred to as “immersion casting” or “wet casting”; and 3) thermally induced phase separation (TIPS), frequently called “melt casting”. The phase inversion process can produce integrally skinned asymmetric membranes. In some embodiments, the membranes may be cross-linked to provide additional support.

The membrane may be designed and fabricated to have specific pore sizes so that solutes having sizes greater than the pore sizes may not be able to pass through. In one embodiment, the pore size may be in a range from about 0.5 nanometers to about 100 nanometers. In another embodiment, the pore size may be in a range from about 1 nanometer to about 25 nm

Also provided herein is a method of forming a hollow-fiber membrane described herein. The method includes providing a casting solution comprising the polymer blend as described earlier and a solvent. The method further includes extruding the casting solution through an annular channel to form the hollow-fiber membrane. Non-limiting examples of suitable solvents include N-methyl-2-pyrrolidone, dimethylacetamide, dimethylformamide, tetrahydrofuran, methyl ethyl ketone, formylpiperidine, or combinations thereof.

In some embodiments, the casting solution may further include an additive selected from the group consisting of polymers, such as, polyvinylpyrrolidone and polyethylene glycol; anti-solvents, such as, water, alcohols, glycols, glycol ethers, and salts; alkali metal halides; and combinations thereof. In some embodiments, the additive may include an alkali metal bromide, such as, but not limited to, lithium bromide, sodium bromide, potassium bromide, cesium bromide, or combinations thereof.

The additive may be present in the casting solution in an amount (total amount) in a range from about 0.1 weight percent to about 30 weight percent, in some embodiments. Further, the sulfone polymer and the sulfone polymer comprising zwitterionic functionality are present in the casting solution in an amount in a range from about 10 weight percent to about 30 weight percent of the weight of the casting solution.

In some embodiments, any hollow fiber membrane blend described above includes at least one additional polymer. The additional polymer may be blended with the polymer blend described above to impart different properties such as better heat resistance, biocompatibility, and the like. Furthermore, the additional polymer may be added to the casting solution during the membrane formation to modify the morphology of the phase inverted membrane structure produced upon phase inversion, such as asymmetric membrane structures. In some instances, the additional polymer may be a sulfone polymer which persists in the final membrane and/or an additive (e.g., PVP, PEG and the like) which is lost in the fabrication process but is not completely removed. Such membranes are also contemplated within the scope of embodiments presented herein.

In some embodiments, the additional polymer blended is a hydrophilic polymer. Non-limiting examples of suitable hydrophilic polymers include polyvinylpyrrolidone (PVP), polyoxazoline, polyethyleneglycol, polypropylene glycol, polyglycolmonoester, polymer of polyethyleneglycol with polypropylene glycol, water-soluble cellulose derivative, polysorbate, polyethylene-polypropylene oxide polymer, polyethyleneimine, and combinations thereof. In some embodiments, the casting solution blend may comprise additional polymers, such as, polyether urethane, polyamide, polyether-amide, polyacrylonitrile, and combinations thereof.

The membranes described herein have use in various applications, such as, bio-separation, water purification, hemofiltration, hemodialysis, ultrafiltration, nanofiltration, gas separation, microfiltration, reverse osmosis, and pervaporation. In particular embodiments, the membranes may have applications in the biopharmaceutical and biomedical field where improved hydrophilicity and biocompatibility are desired.

In some embodiments, provided herein is a hollow-fiber membrane for bio-separation. A hollow-fiber membrane suitable for bio-separation is characterized in part by the protein binding. In some embodiments, the hollow-fiber membranes provided herein have protein binding less than about 30 ng/cm̂². The membrane is composed of a polymer blend as described herein. In another aspect, provided herein is a bio-separation apparatus that includes a plurality of porous hollow fibers composed of the porous membranes provided herein.

In some embodiments, the membranes described herein are used for hemodialysis. Dialysis refers to a process effected by one or more membranes in which transport is driven primarily by pressure differences across the thickness of the one or more membrane. Hemodialysis refers to a dialysis process in which biologically undesired and/or toxic solutes, such as metabolites and by-products are removed from blood. Hemodialysis membranes are porous membranes permitting the passage of low molecular weight solutes, typically less than 5,000 Daltons, such as urea, creatinine, uric acid, electrolytes and water, yet preventing the passage of higher molecular weight proteins and blood cellular elements. Hemofiltration, which more closely represents the filtration in the glomerulus of the kidney, requires even more permeable membranes allowing complete passage of solutes of molecular weight of less than 50,000 Daltons, and, in some cases, less than 20,000 Daltons

The polymer blends described herein confer the desired mechanical properties so as to support the porous hollow-fiber membrane structure during manufacture and use. In addition, the polymer blends confer adequate thermal properties so as to reduce or prevent degradation during high temperature steam sterilization processes. Further, the polymer blends and membranes have optimal biocompatibility, such that protein fouling is minimized and thrombosis of the treated blood does not occur.

### Examples

Chemicals were purchased from Aldrich and Sloss Industries and used as received, unless otherwise noted. NMR spectra were recorded on a Bruker Avance 400 (¹H, 400 MHz) spectrometer and referenced versus residual solvent shifts. Molecular weights are reported as number average (Mₙ) or weight average (M_{w}) molecular weight and were determined by gel permeation chromatography (GPC) analysis on a Perkin Elmer Series 200 instrument equipped with UV detector. Polymer thermal analysis was performed on a Perkin Elmer DSC7 equipped with a TACT/DX thermal analyzer and processed using Pyris Software.

Glass transition temperatures were recorded on the second heating scan. Contact angle measurements were taken on a VCA 2000 (Advanced Surface Technology, Inc.) instrument using VCA optima Software for evaluation. Polymer films were obtained from casting a thin film from an appropriate solution, such as, dimethyl sulfoxide (DMSO), N-methyl-2-pyrrolidone (NMP), and dimethylacetamide (DMAC) onto a clean glass slide and evaporation of the solvent. Advancing contact angles with water (73 Dynes/cm) were determined on both sides of the film (facing air and facing glass slide). Consistently lower values were obtained on the side facing the glass slide presumably due to the smoother surface.

### Synthesis of Sulfone Polymer Having Zwitterionic Functionality

The preparation of a polymer of formula (VII) and final derivatization to 45 mole % Zwitterion (one pot synthesis, 3.25 mole % chain stopper) was carried out as follows: To a 5.0 L three neck flask equipped with an overhead mechanical stirrer, shorthead distillation apparatus, and a nitrogen inlet was charged bis phenol A (BPA) (228.1 g, 1.000 moles), N-methyl piperazine diphenolamide (301.17 g, 0.8182 moles), p-cumyl phenol (12.468 g, 0.0591 moles), and 1.60 L N-methyl pyrrolidinone (NMP) immersed in an oil bath. This mixture was stirred at room temperature then potassium carbonate (401.5 g, 2.909 moles) was added in portions followed by 0.800 L of toluene. This mixture was heated under a slow stream of nitrogen to remove toluene followed by azeotropic removal of residual water to dry the reaction mixture. The oil bath temperature was gradually raised from 125-150° C. to remove most of the toluene (>90%). The slurry was then cooled to room temperature then difluorodiphenyl sulfone (469.63 g, 1.8482 moles) was added as a solid and the reaction temperature was gradually raised to 165° C. During the heat up a mild exotherm was observed at about 100° C. The mixture was heated and samples taken every two hours until the desired molecular weight was achieved (8-10 hrs). The reaction viscosity increased over the course of the run with the reaction showing an opaque greyish color. When the desired molecular weight was achieved the reaction was diluted with 0.8 liters of NMP and cooled to 50° C. 1,3-Propane sultone was then added (149.7 g, 1.227 moles) and the reaction mixture gradually heated to 80° C. The reaction was complete in ˜4 hrs. Gradually after the addition is complete the reaction color lightens to an off-white slurry. Based on solution viscosity the reaction mixture may be diluted further. The mixture was then precipitated into 12.0 L of water using a high speed blender, producing a white precipitate. The precipitate was collected by filtration then re-slurried in 5.0 liters of warm water (40-50° C.) for 6 hours. The solid was collected by filtration. The resulting polymer was dried under vacuum initially at 50° C. under a purge of nitrogen for 24 hrs then an additional 24 hrs at 80-100° C. under full vacuum to provide approximately 950 grams of polymer after drying (˜95% recovery).

Casting of hollow fiber membranes was carried out using methods known in the art and using methods described herein. Polymer blends were prepared by dissolving the polymers in a suitable solvent. Dope solutions for casting hollow fiber membranes were prepared by dissolving the polymer blends and any optional additives in a suitable solvent.

### Test for Protein Binding

Nonspecific protein binding was measured using an immunoglobulin protein labeled with a horse-radish peroxidase (HRP) functional group. One-inch long pieces of each hollow fiber were placed in 35×10 mm petri dishes and washed thoroughly in phosphate buffered saline (pH=7.4) to remove residual glycerol, salts, or porogens from the fibers. The PBS was replaced with 2 ml of a 10 μg/ml solution of HRP-protein. After 2 hours of soaking, the antibody solution was removed and the fibers were washed thoroughly with PBS. The fibers were then cut into quarters, and the 4 quarters were transferred collectively to the wells of a 24-well plate containing 0.5 ml 50 mM citrate-phosphate buffer (CPB) (pH=5). The samples were soaked for 30 minutes.

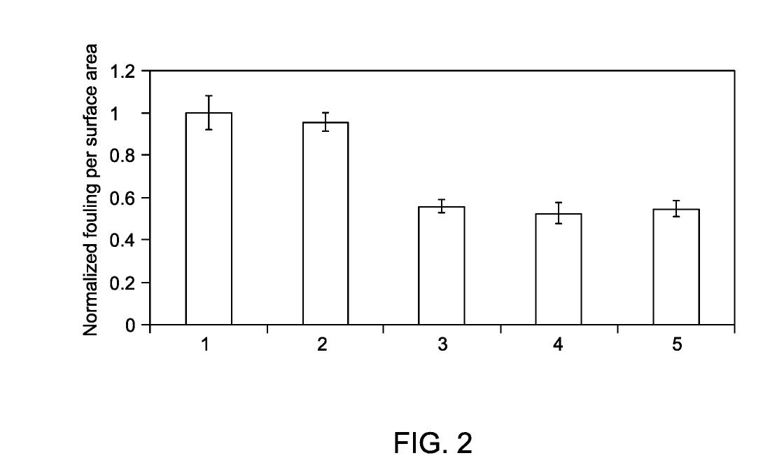

The CPB was replaced with 0.5 ml of a CPB-based solution containing 0.5 mg/ml o-phenylenediamine (OPD) and 0.015% hydrogen peroxide. The HRP tag on the protein converts the OPD to a yellow colored dissolved compound. After 3 minutes, the solution was transferred to small-volume disposable cuvette. The absorbance was measured at 450 nm to quantify the amount of converted OPD, which is directly proportional to the amount of protein nonspecifically adsorbed onto the surface of the membrane. This quantity was normalized by membrane surface area (including inner and outer lumen, as well as the exposed cross-sectional faces. The results are shown in FIG. 2.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A hollow-fiber membrane, comprising a blend of a first polymer comprising a sulfone polymer having zwitterionic functionality and a second polymer comprising a sulfone polymer.

2. The hollow-fiber membrane of claim 1, wherein the first polymer comprising a sulfone polymer having zwitterionic functionality comprises structural units of formula IA or formula IB attached to structural units of formula II: 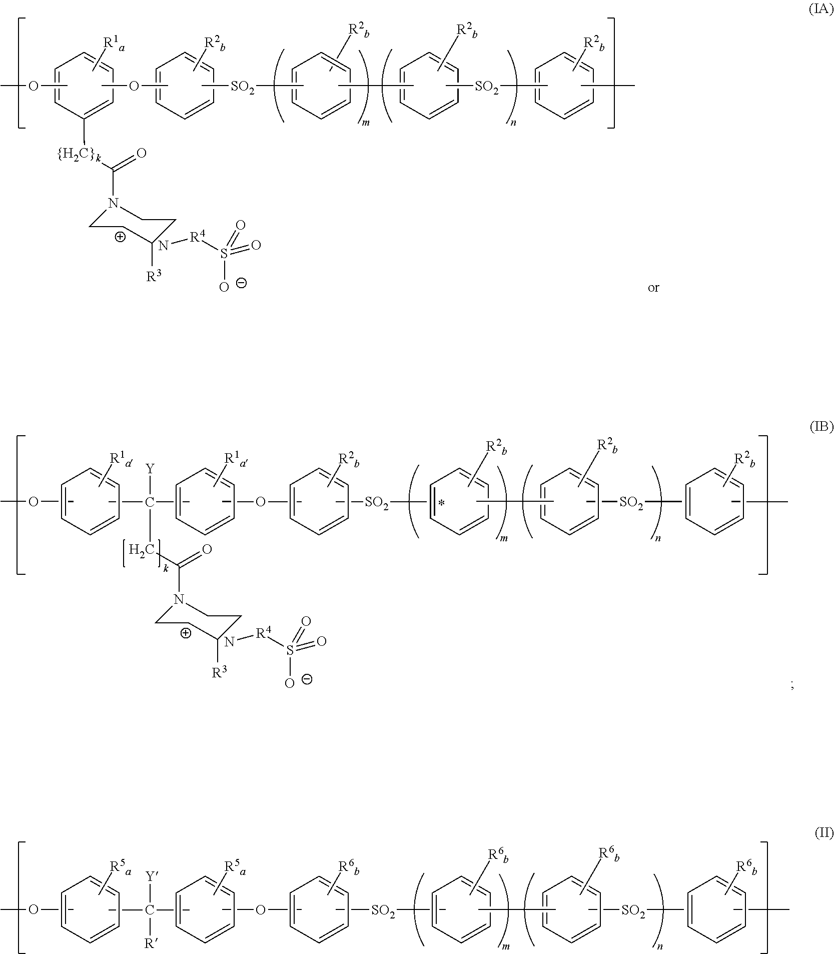
wherein
R¹ and R² are independently at each occurrence a hydrogen atom, a halogen atom, a nitro group, a C₁-C₁₂ alkyl, a C₃-C₁₂ cycloalkyl, or an aryl ring;
k is from 0 to 10;
Y′ and R′ are each, independently, hydrogen, C₁-C₂₀ alkyl, or an aryl ring;
R⁴ is a bond, a C₁-C₁₂ alkyl, a C₃-C₁₂ cycloalkyl, or an aryl ring;
R⁵ and R⁶ are independently at each occurrence a hydrogen atom, a halogen atom, a nitro group, a C₁-C₁₂ alkyl, a C₃-C₁₂ cycloalkyl, or an aryl ring; and
Y′ and R′ are each, independently, hydrogen, C₁-C₂₀ alkyl, or an aryl ring;
a, a′ and b are independently at each occurrence 0, 1, 2, 3, or 4; and
m and n are each, independently, 0 or 1.

3. The hollow-fiber membrane of claim 1, wherein the second polymer comprising a sulfone polymer comprises structural units having the structure of formula II, III IV, or V 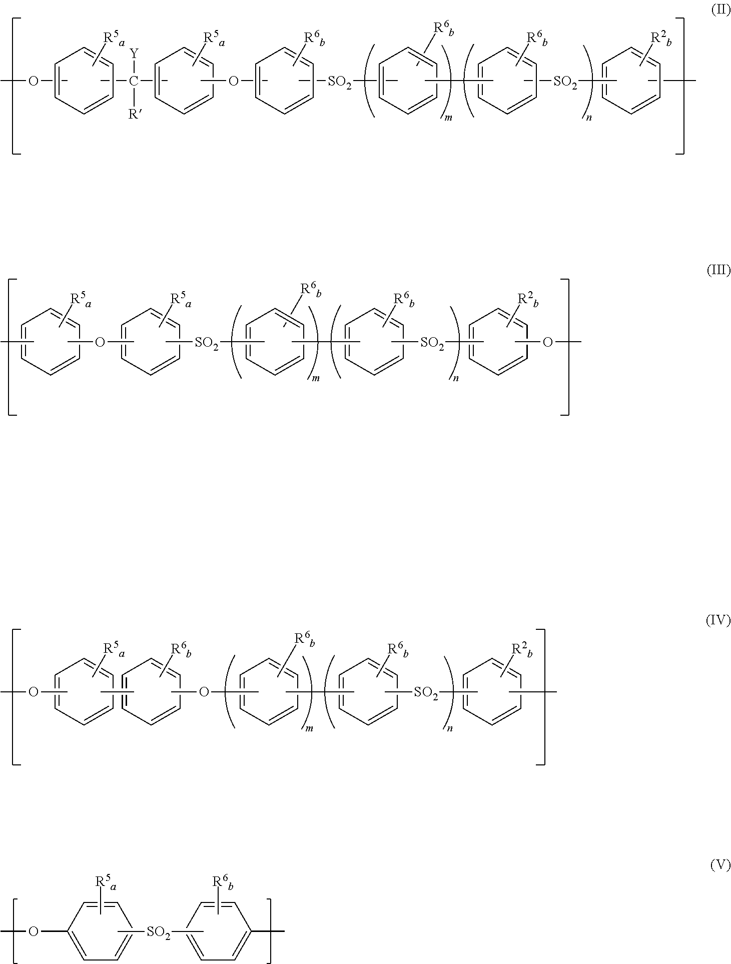
wherein
R⁵ and R⁶ are independently at each occurrence a hydrogen atom, a halogen atom, a nitro group, a C₁-C₁₂ alkyl, a C₃-C₁₂ cycloalkyl, or an aryl ring; and
Y′ and R′ are each, independently, hydrogen, C₁-C₂₀ alkyl, or an aryl ring;
a and b are independently at each occurrence 0, 1, 2, 3, or 4; and
m and n are each, independently, 0 or 1.

4. The hollow-fiber membrane of claim 1, wherein the first polymer comprising a sulfone polymer having zwitterionic functionality comprises structural units of formula IA or formula IB attached to structural units of formula II: 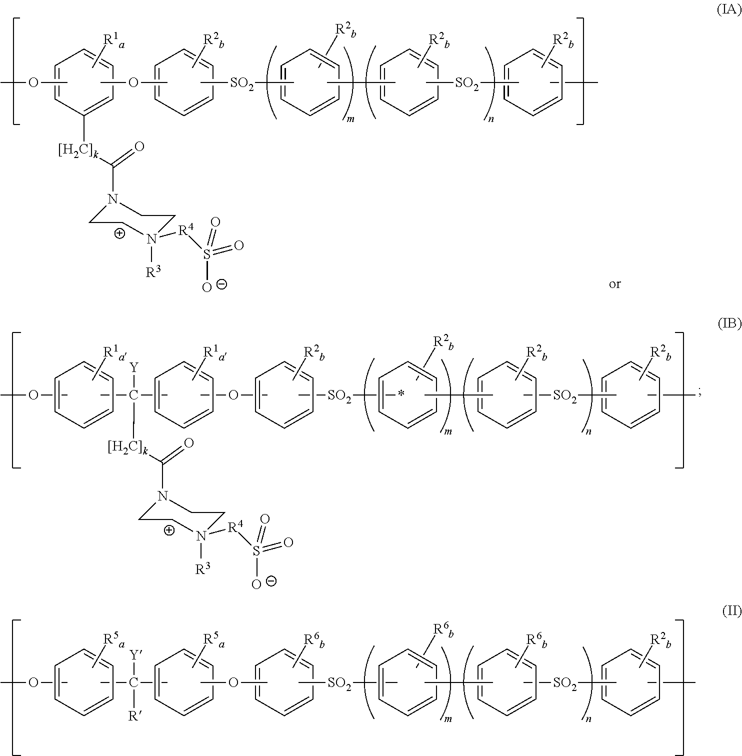
wherein
R¹ and R² are independently at each occurrence a hydrogen atom, a halogen atom, a nitro group, a C₁-C₁₂ alkyl, a C₃-C₁₂ cycloalkyl, or an aryl ring;
k is from 0 to 10;
Y′ and R′ are each, independently, hydrogen, C₁-C₂₀ alkyl, or an aryl ring;
R⁴ is a bond, a C₁-C₁₂ alkyl, a C₃-C₁₂ cycloalkyl, or an aryl ring;
R⁵ and R⁶ are independently at each occurrence a hydrogen atom, a halogen atom, a nitro group, a C₁-C₁₂ alkyl, a C₃-C₁₂ cycloalkyl, or an aryl ring; and
Y′ and R′ are each, independently, hydrogen, C₁-C₂₀ alkyl, or an aryl ring;
a, a′ and b are independently at each occurrence 0, 1, 2, 3, or 4;
m and n are each, independently, 0 or 1; and
wherein the second polymer comprising a sulfone polymer comprises structural units having the structure of formula II, IV, or V

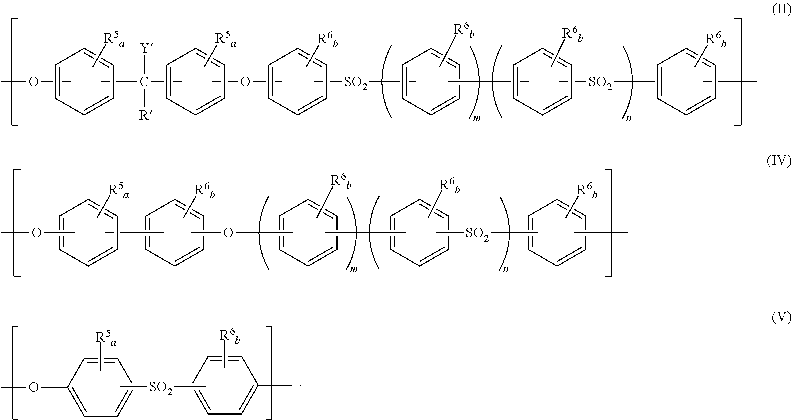

5. The hollow-fiber membrane of claim 2, wherein the first polymer comprising a sulfone polymer having zwitterionic functionality comprises structural units of formula VI: 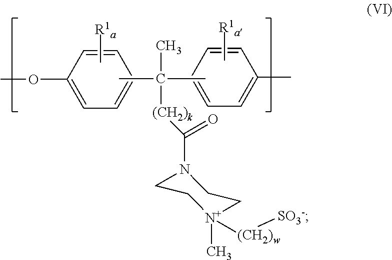
wherein w is 0, 1, 2, or 3.

6. The hollow-fiber membrane of claim 2, wherein the first polymer comprising a sulfone polymer having zwitterionic functionality comprises structural units of formula VII: 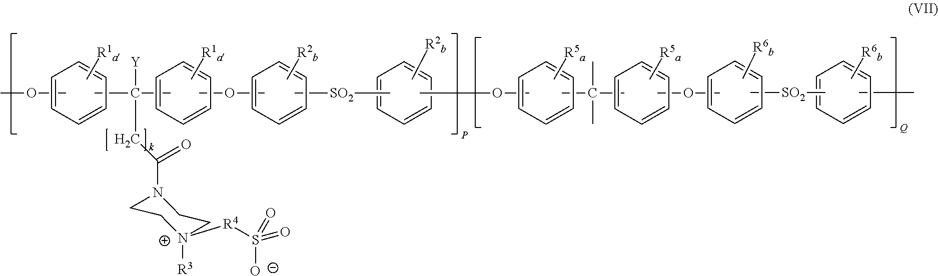
wherein P+Q=1, P=0.30-0.50, Q=0.50-0.70.

7. The hollow-fiber membrane of claim 6, wherein the mole fraction of the zwitterion-functionalized structural units of formula IB in the first polymer is in a range from about 30 mole percent to about 50 mole percent of the total moles of the units of formula IB and formula II in the first polymer.

8. The hollow-fiber membrane of claim 1, wherein the molecular weight of the first polymer comprising a sulfone polymer having zwitterionic functionality is in a range from about 10000 g/mol to about 80000 g/mol.

9. The hollow-fiber membrane of claim 3, wherein the second polymer comprising a sulfone polymer comprises a polysulfone comprising structural units of formula II.

10. The hollow-fiber membrane of claim 3, wherein the second polymer comprising a sulfone polymer comprises a polyphenyl sulfone comprising structural units of formula IV.

11. The hollow-fiber membrane of claim 3, wherein the second polymer comprising a sulfone polymer comprises a polyethersulfone comprising structural units of formula V.

12. The hollow-fiber membrane of claim 1, wherein the second polymer comprising a sulfone polymer is in an amount from about 0.5 weight % to about 5 weight % of the total weight of polymer in the membrane.

13. The hollow-fiber membrane of claim 1, wherein the molecular weight of the second polymer comprising a sulfone polymer is in a range from about 50000 g/mol to about 80000 g/mol.

14. The hollow-fiber membrane of claim 4, wherein the first polymer comprising a sulfone polymer having zwitterionic functionality comprises structural units of formula IB attached to structural units of formula II, and the second polymer comprising a sulfone polymer comprises structural units of formula II

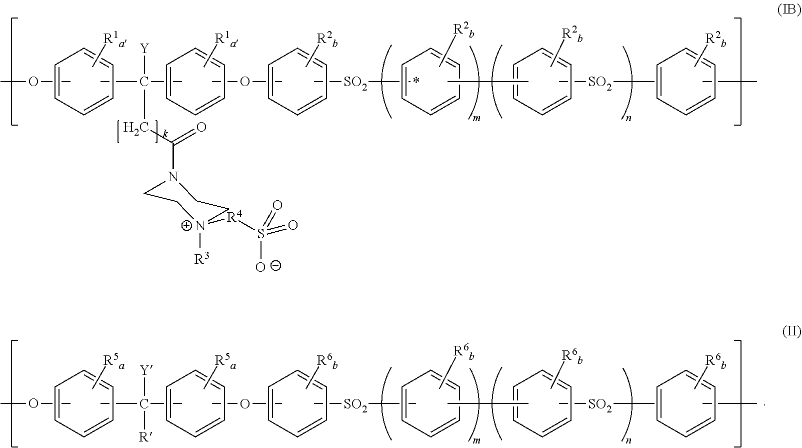

15. The hollow-fiber membrane of claim 4, wherein the first polymer comprising a sulfone polymer having zwitterionic functionality comprises structural units of formula IB attached to structural units of formula II, and the second polymer comprising a sulfone polymer comprises structural units of formula IV

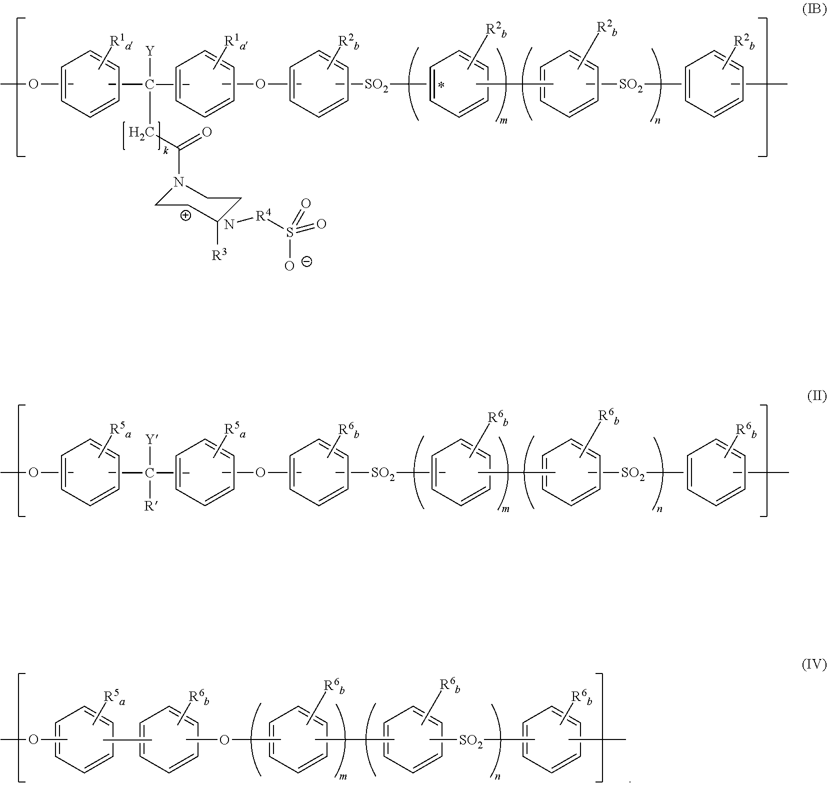

16. The hollow-fiber membrane of claim 4, wherein the first polymer comprising a sulfone polymer having zwitterionic functionality comprises structural units of formula IB attached to structural units of formula II, and the second polymer comprising a sulfone polymer comprises structural units of formula V

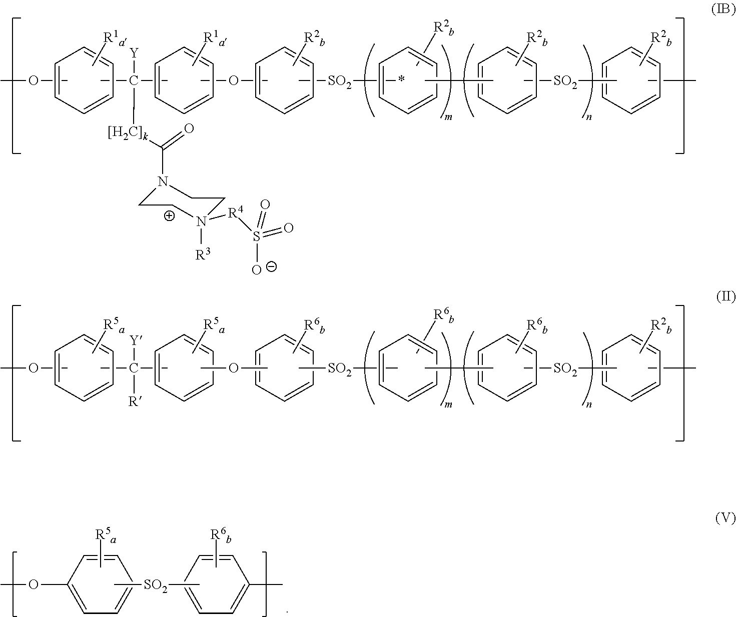

17. A hollow-fiber membrane module comprising a plurality of hollow-fiber membranes of claim 14.

18. A hemodialysis or hemofiltration apparatus comprising the hollow-fiber membrane module of claim 17.

19. A hollow-fiber membrane module comprising a plurality of hollow-fiber membranes of claim 15.

20. A hemodialysis or hemofiltration apparatus comprising the hollow-fiber membrane module of claim 19.

21. A hollow-fiber membrane module comprising a plurality of hollow-fiber membranes of claim 16.

22. A hemodialysis or hemofiltration apparatus comprising the hollow-fiber membrane module of claim 21.

23. A composition comprising a blend of a first polymer comprising a sulfone polymer having zwitterionic functionality and a second polymer comprising a sulfone polymer.

24. The composition of claim 23, wherein the first polymer comprising a sulfone polymer having zwitterionic functionality comprises structural units of formula IB attached to structural units of formula II, and the second polymer comprising a sulfone polymer comprises structural units of formula II 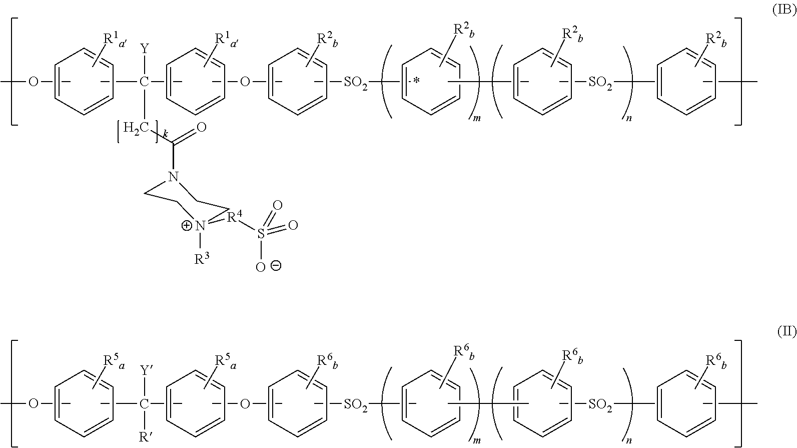
wherein
R¹ and R² are independently at each occurrence a hydrogen atom, a halogen atom, a nitro group, a C₁-C₁₂ alkyl, a C₃-C₁₂ cycloalkyl, or an aryl ring;
k is from 0 to 10;
R³ and Y are independently a hydrogen atom, a C₁-C₁₂ alkyl, a C₃-C₁₂ cycloalkyl, or an aryl ring;
R⁴ is a bond, a C₁-C₁₂ alkyl, a C₃-C₁₂ cycloalkyl, or an aryl ring;
R⁵ and R⁶ are independently at each occurrence a hydrogen atom, a halogen atom, a nitro group, a C₁-C₁₂ alkyl, a C₃-C₁₂ cycloalkyl, or an aryl ring;
a, a′ and b are independently at each occurrence 0, 1, 2, 3, or 4; and
m and n are each, independently, 0 or 1.

25. The composition of claim 23, wherein the first polymer comprising a sulfone polymer having zwitterionic functionality comprises structural units of formula IB attached to structural units of formula II, and the second polymer comprising a sulfone polymer comprises structural units of formula IV 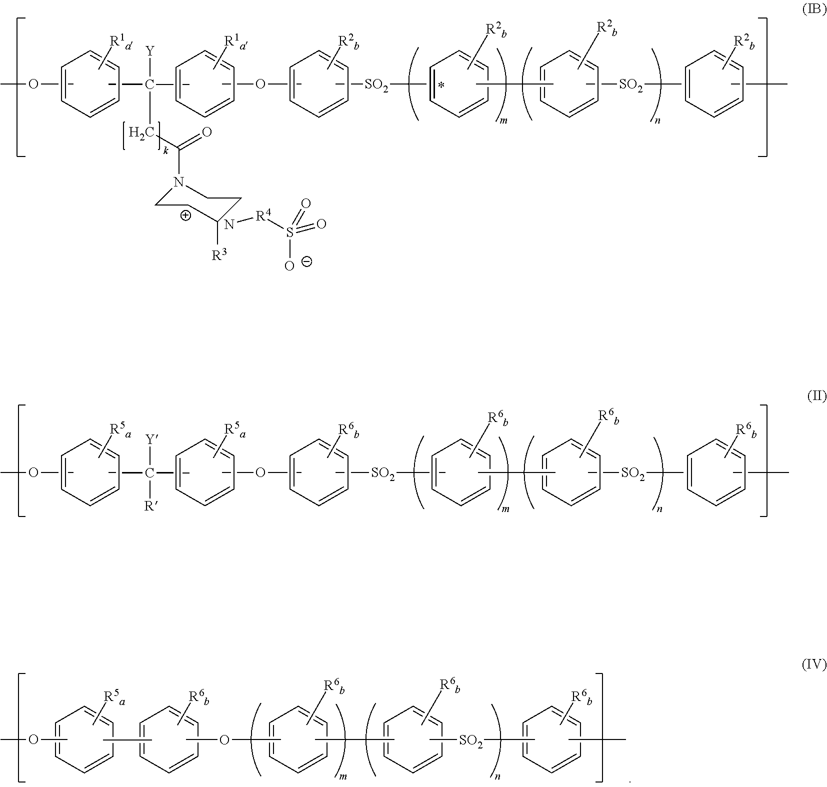
wherein
R¹ and R² are independently at each occurrence a hydrogen atom, a halogen atom, a nitro group, a C₁-C₁₂ alkyl, a C₃-C₁₂ cycloalkyl, or an aryl ring;
k is from 0 to 10;
R³ and Y are independently a hydrogen atom, a C₁-C₁₂ alkyl, a C₃-C₁₂ cycloalkyl, or an aryl ring;
R⁴ is a bond, a C₁-C₁₂ alkyl, a C₃-C₁₂ cycloalkyl, or an aryl ring;
R⁵ and R⁶ are independently at each occurrence a hydrogen atom, a halogen atom, a nitro group, a C₁-C₁₂ alkyl, a C₃-C₁₂ cycloalkyl, or an aryl ring;
a, a′ and b are independently at each occurrence 0, 1, 2, 3, or 4; and
m and n are each, independently, 0 or 1.

26. The composition of claim 23, wherein the first polymer comprising a sulfone polymer having zwitterionic functionality comprises structural units of formula IB attached to structural units of formula II, and the second polymer comprising a sulfone polymer comprises structural units of formula V 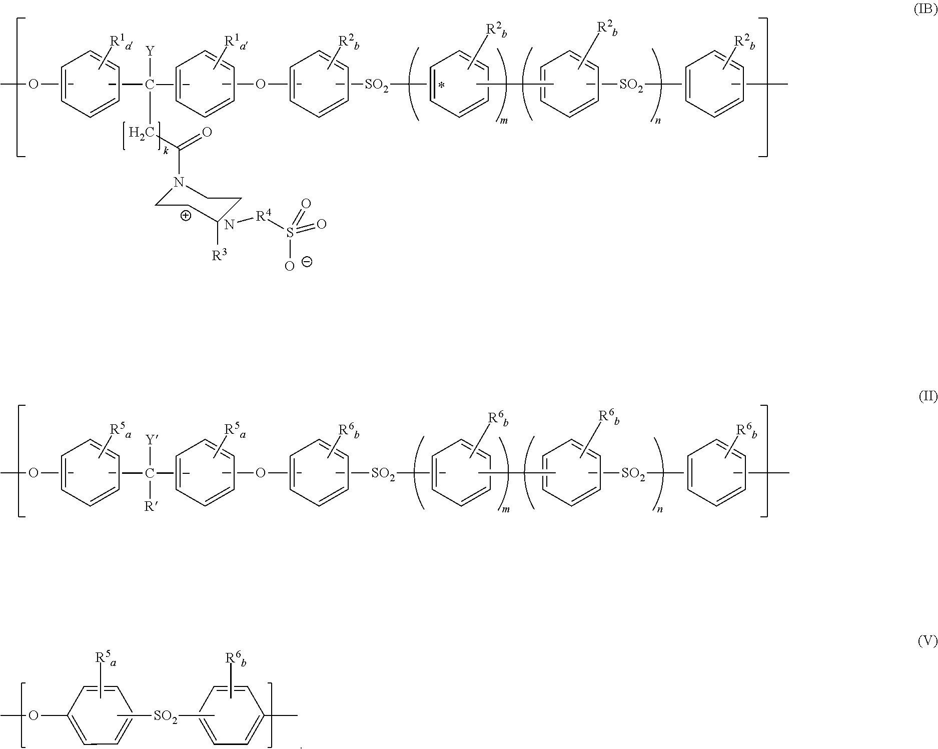
wherein
R¹ and R² are independently at each occurrence a hydrogen atom, a halogen atom, a nitro group, a C₁-C₁₂ alkyl, a C₃-C₁₂ cycloalkyl, or an aryl ring;
k is from 0 to 10;
R³ and Y are independently a hydrogen atom, a C₁-C₁₂ alkyl, a C₃-C₁₂ cycloalkyl, or an aryl ring;
R⁴ is a bond, a C₁-C₁₂ alkyl, a C₃-C₁₂ cycloalkyl, or an aryl ring;
R⁵ and R⁶ are independently at each occurrence a hydrogen atom, a halogen atom, a nitro group, a C₁-C₁₂ alkyl, a C₃-C₁₂ cycloalkyl, or an aryl ring;
a, a′ and b are independently at each occurrence 0, 1, 2, 3, or 4; and
m and n are each, independently, 0 or 1.

27. A process for forming a hollow-fiber membrane of claim 1, comprising:
(A) providing a casting solution comprising a blend of the first polymer and the second polymer, wherein the total polymer content in the casting solution is less than about 20% by weight of the casting solution; and
(B) extruding the casting solution through an annular channel to form the hollow-fiber membrane.

28. The method of claim 27, wherein the hollow-fiber membrane comprises the second polymer in an amount from about 0.5 weight % to about 5 weight % of the total weight of polymer in the membrane.
